(19) United States
(12) Patent Application Publication
(10) Pub. No.: US 2015/0264536 A1
(43) Pub. Date: Sep. 17, 2015

(54) MOBILE DEVICE LOCATING USING LIMITED ACCESS POINTS

(71) Applicant: QUALCOMM Incorporated, San Diego, CA (US)

(72) Inventors: Milind H. PATIL, Santa Clara, CA (US); Sunil A. PATEL, Fremont, CA (US); Gaurav LAMBA, Los Altos, CA (US)

(73) Assignee: QUALCOMM Incorporated, San Diego, CA (US)

(21) Appl. No.: 14/216,828

(22) Filed: Mar. 17, 2014

(51) Int. Cl. H04W 4/04; H04W 4/02

(52) U.S. Cl. CPC H04W 4/043; H04W 4/028

(57) ABSTRACT

A method of determining a present location of a mobile device within a structure includes: obtaining a prior location of the mobile device, the prior location being on a first floor of the structure; and in response to the prior location being indicative of the present location being remote from a floor transition, using a first set of access points to determine the present location, the first set of access points disposed only on the first floor; or in response to the prior location being indicative of the present location being proximate to the floor transition, using a second set of access points to determine the present location of the mobile device, the second set of access points comprising one or more access points disposed on the first floor and one or more access points disposed on the second floor, the second floor being separate from the first floor.

### BACKGROUND

When performing positioning in an indoor environment, determining a region, including disambiguating between different regions of the indoor environment is useful, if not critical. Indoor regions may be different floors of a building or portions of floors in a building or different portions of a floor. Signals from wireless transceiver access points (APs) in different regions can be received by a single mobile station (MS). In large facilities, using signals from APs that are far away from an MS may use more network bandwidth than is desirable. Even though the MS is in a first region, the signal strength received from an AP in a second, different, region may be stronger than the signal strength of a signal received from an AP in the first region. This is especially true near portals such as staircases and elevator shafts, e.g., due to waveguide effects of these structures.

Disambiguating mobile device location between different indoor floors can be difficult and use a lot of resources, e.g., many WiFi access point bandwidth and power. Mobile device location can be determined using information from available WiFi access points (e.g., with which sufficient signal quality communication exists). This typically provides ample information from which to determine the mobile device's location.

### SUMMARY

An example method of determining a present location of a mobile device within a structure includes: obtaining a prior location of the mobile device within the structure, the prior location being on a first floor of the structure; and in response to the prior location being indicative of the present location being remote from a floor transition, using a first set of access points to determine the present location of the mobile device, the first set of access points comprising access points disposed only on the first floor of the structure; or in response to the prior location being indicative of the present location being proximate to the floor transition, using a second set of access points to determine the present location of the mobile device, the second set of access points comprising one or more access points disposed on the first floor of the structure and one or more access points disposed on the second floor of the structure, the second floor of the structure being separate from the first floor of the structure.

Implementations of such a method may include one or more of the following features. The method further includes determining whether the prior location is indicative of the present location being remote from or proximate to the floor transition by determining whether the prior location is within a transition-threshold distance of the floor transition. Each of the access points in the second set of access points is disposed within a communication-threshold distance of the floor transition on either the first floor or the second floor, respectively. Access point signals from all of the access points in the second set of access points have expected received signal strengths of at least a threshold level proximate to the floor transition on the first floor. The access points in the first set of access points are each separated from the prior location by a respective distance that is equal to or less than a threshold distance when the prior location is indicative of the present location being remote from a floor transition. Expected received signal strengths, at the prior location, from the access points in the first set of access points are all equal to or greater than a threshold signal strength when the prior location is indicative of the present location being remote from a floor transition. The method further includes determining whether the prior location is indicative of the present location being remote from or proximate to the floor transition by determining a distance between an estimated position of the mobile device, based on the prior location, relative to the floor transition. The method further includes determining a likeliness of an imminent floor change.

An example of a mobile wireless telecommunications device includes: prior-location obtaining means for obtaining a prior location of the mobile wireless telecommunications device, the prior location being on a first floor of the structure; first present-location determining means for determining, in response to the prior location of the mobile wireless telecommunications device being on the first floor and remote from a floor transition, a present location of the mobile wireless telecommunications device using a first set of access points disposed only on the first floor of the structure; and second present-location determining means for determining, in response to the prior location of the mobile wireless telecommunications device being proximate to the floor transition, the present location of the mobile wireless telecommunications device using a second set of access points, including at least one access point disposed on the first floor and at least one access point disposed on a second floor of the structure, the second floor of the structure being separate from the first floor of the structure.

Implementations of such a mobile wireless telecommunications device may include one or more of the following features. The mobile wireless telecommunications device further includes floor-change likeliness means for providing a likeliness indicator indicating that an imminent floor change of the mobile wireless telecommunications device is either likely or not likely. The floor-change likeliness means are for determining a proximity of the mobile wireless telecommunications device to a floor-transition.

An example of a processor-readable storage medium includes processor-readable instructions to cause a processor to: obtain a prior location of a mobile device within a structure, the prior location being on a first floor of the structure; and in response to the prior location being indicative of the present location being remote from a floor transition, use a first set of access points to determine the present location of the mobile device, the first set of access points comprising access points disposed only on the first floor; or in response to the prior location being indicative of the present location being proximate to the floor transition, use a second set of access points to determine the present location of the mobile device, the second set of access points comprising one or more access points disposed on the first floor of the structure and one or more access points disposed on the second floor of the structure, the second floor of the structure being separate from the first floor of the structure.

Implementations of such a storage medium may include one or more of the following features. The storage medium further includes instructions to cause the processor to determine whether the prior location is indicative of the present location being remote from or proximate to the floor transition by determining whether the prior location is within a transition-threshold distance of the floor transition. The storage medium further includes instructions to cause the processor to determine the access points in the second set of access points such that each of the access points in the second set of access points is disposed within a communication-threshold distance of the floor transition on either the first floor or the second floor, respectively. The storage medium further includes instructions to cause the processor to determine the access points in the second set of access points such that access point signals from all of the access points in the second set of access points have expected received signal strengths of at least a threshold level proximate to the floor transition on the first floor. The storage medium further includes instructions to cause the processor to determine the access points in the first set of access points such that the access points in the first set of access points are each separated from the prior location by a respective distance that is equal to or less than a threshold distance when the prior location is indicative of the present location being remote from a floor transition. The storage medium further includes instructions to cause the processor to determine the access points in the first set of access points such that expected received signal strengths, at the prior location, from the access points in the first set of access points are all equal to or greater than a threshold signal strength when the prior location is indicative of the present location being remote from a floor transition. The storage medium further includes instructions to cause the processor to determine whether the prior location is indicative of the present location being remote from or proximate to the floor transition by determining a distance between an estimated position of the mobile device, based on the prior location, relative to the floor transition. The storage medium further includes instructions to cause the processor to determine a likeliness of an imminent floor change.

Items and/or techniques described herein may provide one or more of the following capabilities, as well as other capabilities not mentioned. Mobile device locating, including region disambiguating as appropriate, may be performed using less than all available resources, e.g., less than all received access point signals. Mobile device locating may be improved, particularly for floor transitions. Incorrect determinations of floor transition in the presence of one or more faulty access points may be reduced. Bandwidth used for determining a mobile device location fix may be reduced, freeing bandwidth for other uses. A quantity of devices served by an indoor positioning system may be larger than with previous systems. Positioning performance quality of service of a mobile device may be improved, e.g., with improved utilization of network resources, improved power usage (e.g., less power per position fix), improved positioning accuracy, and improved frequency of position fixes (e.g., user may increase or decrease frequency). Further, load balancing of large indoor facilities may be improved, e.g., by using only proximate APs for locating mobile devices. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTIONS OF THE DRAWINGS

FIG. 1 is a simplified diagram of a communication system.

FIG. 2 is a simplified diagram of access points and a mobile device in a structure shown in FIG. 1.

FIGS. 3-6 are block diagrams of a mobile station, a base station, a server shown in FIG. 1, and one of the access points shown in FIGS. 1-2.

FIG. 7 is a table of locations in the structure shown in FIG. 2, expected RSSI at those locations from access points, and locations of those access points.

FIG. 8 is a floor layout of a second floor of a structure shown in FIG. 2, showing prior locations of three mobile devices, and locations of access points.

FIG. 9 is a table of locations in the structure shown in FIG. 2, a list of access points to be used for location determination at each of those locations, and locations of those access points.

FIG. 10 is a functional block diagram of the mobile device shown in FIG. 3.

FIG. 11 is a floor layout of a third floor of the structure shown in FIG. 2, showing locations of access points.

FIG. 12 is a block flow diagram of a process of determining a present location of a mobile device.

FIG. 13 is a schematic diagram of a neural network of the system shown in FIG. 1.

### DETAILED DESCRIPTION

Techniques are provided for adjusting the access points used for determining floor transitions of a mobile device. For example, a mobile device's location on a floor is determined intermittently (e.g., periodically). Based on the most-recent location of the mobile device, access points are selected for the next determination of the mobile device's location. If the mobile device's most recently determined location is not near a floor transition (e.g., outside of a transition-threshold distance from a floor transition (e.g., stairs, escalator, elevator, etc.)), then access points only on the floor of the present location are selected for use in determining the mobile device's next location. Preferably, only access points within good communication range (e.g., within a communication-threshold distance, within an expected RSSI (received signal strength indication) threshold value based on an RSSI heatmap, etc.) of the present location are selected for use in determining the next location. If the mobile device's present location is near a floor transition (e.g., inside of the transition-threshold distance from a floor transition (e.g., stairs, escalator, elevator, etc.)), then access points on the mobile device's present floor and on other floor(s) (e.g., immediately above and/or immediately below) are selected for use in determining the mobile device's next location. The selected access points may be those within good communication range (e.g., within the communication-threshold distance) of the floor transition on each of the selected floors (i.e., the floors on which access points are selected), may be a threshold number (e.g., N access points on each of the present floor and adjacent floors, etc.). The transition-threshold distance and the communication-threshold distance may be different. Other techniques are also possible.

Floors other than the adjacent floors may be selected, even though the discussion below focuses on use of adjacent floors for simplicity. For example, if the transition is associated with a slow floor transition, e.g., stairs, then the other selected floors are preferably the floors immediately adjacent to the present floor, although further floors may be selected. If the transition is associate with rapid multi-floor transitions, e.g., an elevator, then the other selected floors may be the floors that the elevator services. Further, preferably only floors that may be accessed using the transition are selected. For example, if the mobile device is on floor 2 of a five-floor building, and is near a transition that can only access floors above floor 2, then the access points on floor 1 are preferably not selected for use in determining the mobile device's location.

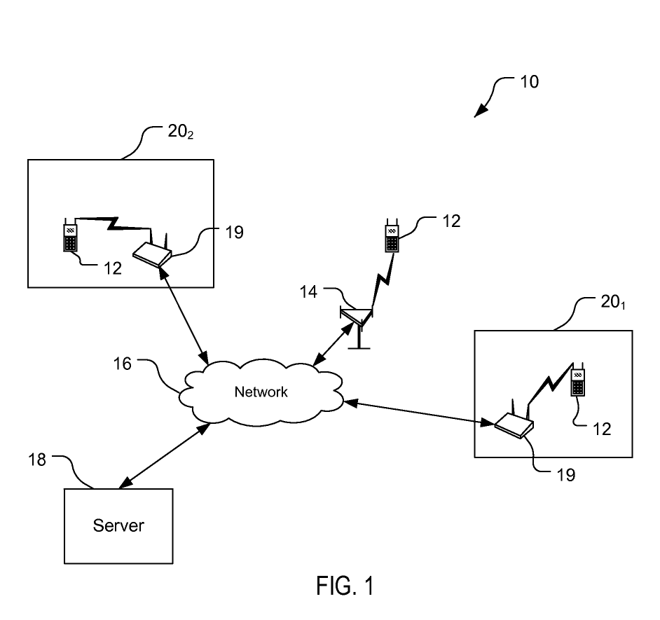

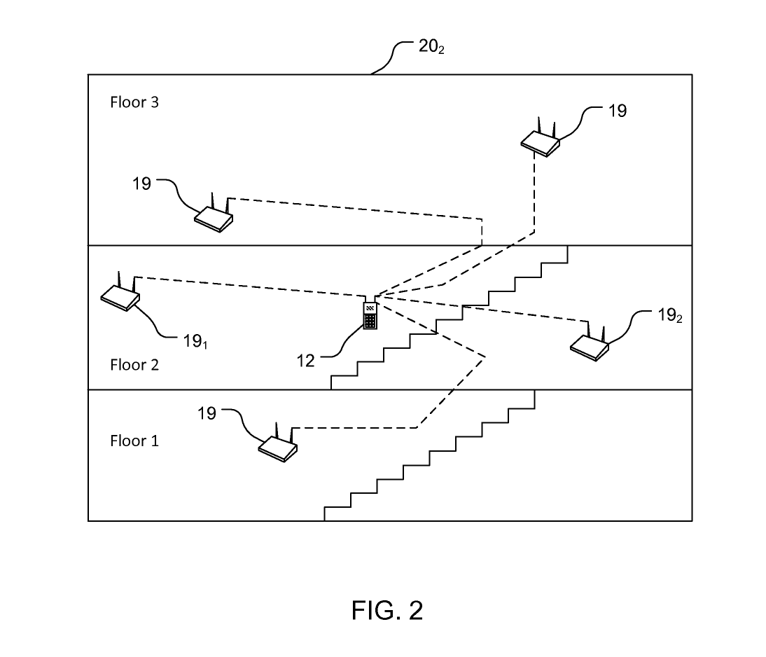

Referring to FIGS. 1-2, a communication system 10 includes mobile devices (MDs) 12, a base transceiver station (BTS) 14, a network 16, a server 18, and wireless transceiver access points (APs) 19 disposed in structures (here buildings) 20. The system 10 is a communication system in that the system 10 can at least send and receive communications. Although only one server 18 is shown for simplicity, more than one server 18 may be used in the system 10, e.g., in various locations to provide quicker access as the system 10 may span large regions, e.g., entire countries or continents, or even the planet.

The BTS 14 can wirelessly communicate with the mobile devices 12 via antennas. Each of the BTSs 14 may also be referred to as an access point, an access node (AN), a Node B, an evolved Node B (Enb), etc. The BTSs 14 are configured to communicate wirelessly with the mobile devices 12 under the control of the server 18 (via the network 16).

The mobile devices 12 can be moved to various locations, including into the structures 20 and onto different floors of the structures 20. The mobile devices 12 may be referred to as access terminals (ATs), mobile stations, user equipment (UE), or subscriber units. The mobile devices 12 are shown here as cellular phones. Other examples of mobile devices include wireless routers, personal digital assistants (PDAs), smartphones, netbooks, notebook computers, tablet computers, etc. Only one mobile device 12 is shown in FIG. 2, and to simplify the discussion below only this mobile device 12 is discussed.

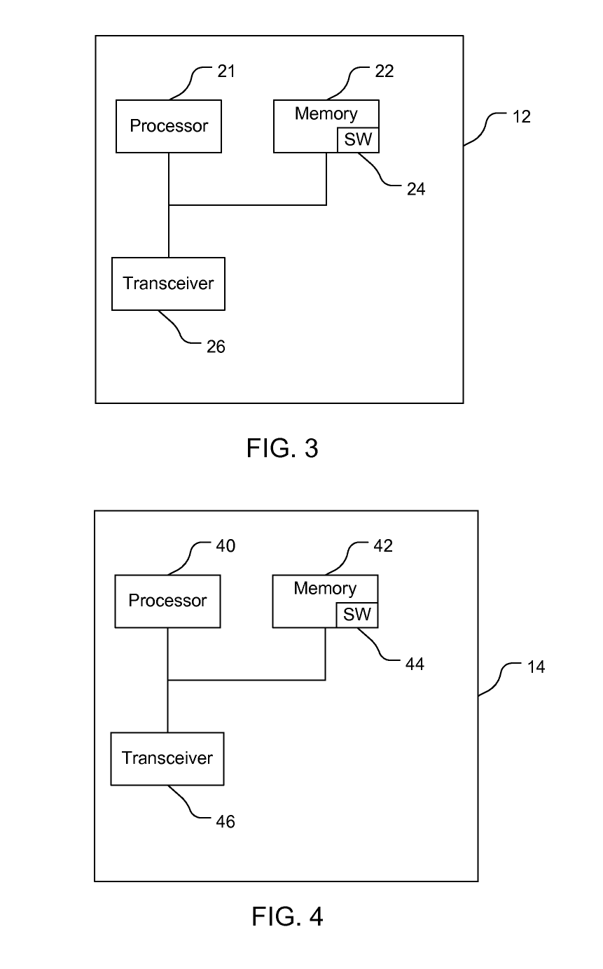

Referring to FIG. 3, an example of one of the mobile devices 12 comprises a computer system including a processor 21, memory 22 including software 24, and a transceiver 26. The transceiver 26 includes one or more appropriate antennas and constitutes a wireless communication module that can communicate bi-directionally with the BTS 14 and with the APs 19 and/or another entity. For example, the antennas may include an antenna for communicating with the BTS 14 and an antenna for communicating with the APs 19, and the transceiver 26 includes multiple transceiver portions, e.g., one for communicating with the BTS 14 and one for communicating with the APs 19. The transceiver 26 is configured to provide received signals to the processor 21 and to send communications to the BTS 14 and/or the APs 19 under the control of the processor 21. The processor 21 is preferably an intelligent hardware device, e.g., a central processing unit (CPU) such as those made by ARM®, Intel® Corporation, or AMD®, a microcontroller, an application specific integrated circuit (ASIC), etc. The processor 21 could comprise multiple separate physical entities that can be distributed in the mobile device 12. The memory 22 includes random access memory (RAM) and read-only memory (ROM). The memory 22 is a processor-readable storage medium that stores the software 24 which is processor-readable, processor-executable software code containing processor-readable instructions that are configured to, when executed, cause the processor 21 to perform various functions described herein (although the description may refer only to the processor 21 performing the functions). Alternatively, the software 24 may not be directly executable by the processor 21 but configured to cause the processor 21, e.g., when compiled and executed, to perform the functions.

Referring also to FIG. 4, the BTS 14 comprises a computer system including a processor 40, memory 42 including software 44, and a transceiver 46. While the BTS 14 is shown with a single processor 40 and a single memory 42 (with corresponding software 44), the BTS 14 may have a processor 40 and a memory 42 (with corresponding software 44) for each sector served by the BTS 14, e.g., each of three sectors. The transceiver 46, that includes any appropriate antennas, is a wireless communication module. The transceiver 46 is configured to communicate bi-directionally with the mobile device 12 via one or more of the antennas of the transceiver 46. The transceiver 46 is configured to provide received signals to the processor 40 and to send communications, e.g., to the MDs 12 and/or the APs 19, under the control of the processor 40.

The processor 40 is preferably an intelligent hardware device, e.g., a central processing unit (CPU) such as those made by ARM®, Intel® Corporation, or AMD®, a microcontroller, an application specific integrated circuit (ASIC), etc. The processor 40 could comprise multiple separate physical entities that can be distributed in the BTS 14. The memory 42 includes random access memory (RAM) and read-only memory (ROM). The memory 42 is a processor-readable storage medium that stores the software 44 which is processor-readable, processor-executable software code containing processor-readable instructions that are configured to, when executed, cause the processor 40 to perform various functions described herein (although the description may refer only to the processor 40 performing the functions). Alternatively, the software 44 may not be directly executable by the processor 40, but configured to cause the processor 40, e.g., when compiled and executed, to perform the functions.

The mobile device 12 and the BTS 14 are configured to communicate with each other wirelessly. The mobile device 12 and the BTS 14 can send messages to each other that contain a variety of information. For example, the BTS 14 can collect information from mobile devices 12 regarding AP signal RSSI that can then be associated with the location of the MD 12 once the location of the MD 12 is determined.

Referring to FIG. 5, the server 18 comprises a computer system including a processor 60, memory 62 including software 64, and a transceiver 66. The processor 60 is preferably an intelligent hardware device, e.g., a central processing unit (CPU) such as those made by ARM®, Intel® Corporation, or AMD®, a microcontroller, an application specific integrated circuit (ASIC), etc. The processor 60 could comprise multiple separate physical entities that can be distributed in the server 18. The memory 62 includes random access memory (RAM) and read-only memory (ROM). The memory 62 is a processor-readable storage medium that stores the software 64 which is processor-readable, processor-executable software code containing processor-readable instructions that are configured to, when executed, cause the processor 60 to perform various functions described herein (although the description may refer only to the processor 60 performing the functions). Alternatively, the software 64 may not be directly executable by the processor 60 but configured to cause the processor 60, e.g., when compiled and executed, to perform the functions. The transceiver 66 is configured to send communications to and receive communications from, i.e., communicate bi-directionally with, the BTS 14 through the network 16. The server 18 and the APs 19 are typically hard-wire connected to the network 16. The transceiver 66 is configured to provide received signals to the processor 60 and to send communications, e.g., to the network 16, under the control of the processor 60.

Referring to FIG. 6, an example of one of the APs 19 comprises a computer system including a processor 80, memory 82 including software 84, and a transceiver 86. The transceiver 86, including any appropriate antenna(s), is configured such that the AP 19 can communicate bi-directionally with the MDs 12. The transceiver 86 is configured to provide received signals to the processor 80 and to send communications, e.g., to the MDs 12, under the control of the processor 80. The processor 80 is preferably an intelligent hardware device, e.g., a central processing unit (CPU) such as those made by ARM®, Intel® Corporation, or AMD®, a microcontroller, an application specific integrated circuit (ASIC), etc. The processor 80 could comprise multiple separate physical entities that can be distributed in the AP 19. The memory 82 includes random access memory (RAM) and read-only memory (ROM). The memory 82 is a processor-readable storage medium that stores the software 84 which is processor-readable, processor-executable software code containing processor-readable instructions that are configured to, when executed, cause the processor 80 to perform various functions described herein (although the description may refer only to the processor 80 performing the functions). Alternatively, the software 84 may not be directly executable by the processor 80 but configured to cause the processor 80, e.g., when compiled and executed, to perform the functions.

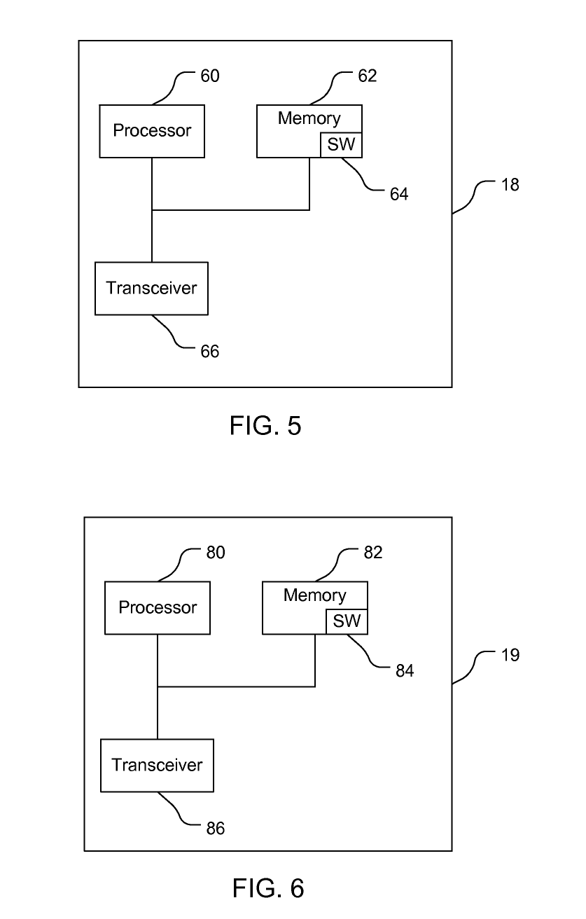

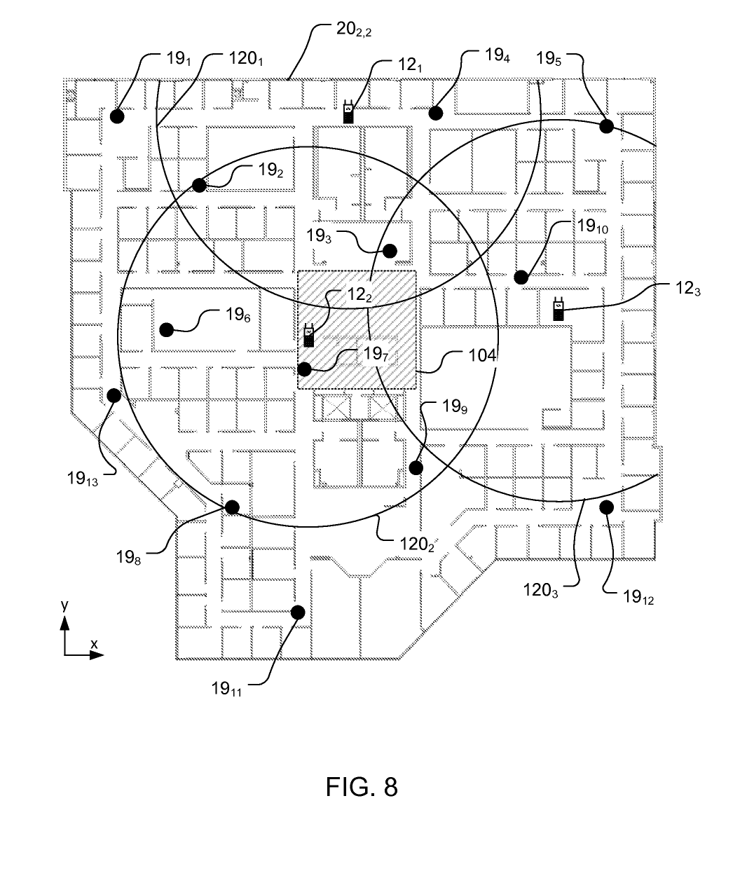

Referring again to FIGS. 1 and 5, the server 18 may provide map information to the MD 12 through the network 16 and one or more of the APs 19. The map information may be provided in any of a variety of forms, may indicate locations of the various APs 19, and may provide a heat map indicating values of one or more parameters (e.g., RSSI) as a function of location in a structure. For example, the map information may be provided in the form of a table indicating AP locations, and expected RSSI corresponding to locations in a structure as discussed more fully below with respect to FIG. 7. Also or alternatively, as shown in FIG. 9 and discussed more fully below, the map information may provide indications of which APs 19 to use, corresponding to locations in a structure, e.g., for determining the location of the MD 12.

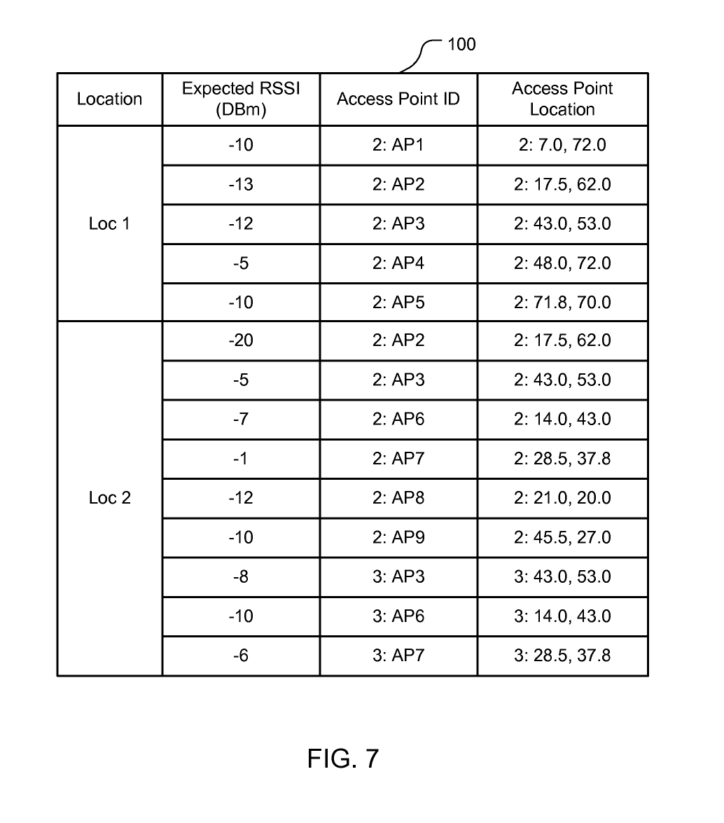

Referring to FIGS. 7-8, with further reference to FIGS. 1-6, a table 100 includes map information for a second floor 20_{2,2} of the structure 20₂. As shown in the example of FIG. 8, the second floor 20_{2,2} contains 13 APs 19₁-19₁₃. Three mobile devices 12₁-12₃ are shown at three different locations on the second floor 20_{2,2}, referred to as locations 1, 2, and 3, respectively. The table 100 is a portion of a larger table, with the table 100 showing only information regarding only some of the APs 19. The table 100 may include information regarding other APs, e.g., all of the APs 19 on the floor 20_{2,2}, and/or other APs 19 on one or more other floors of the structure 20₂. The table 100 includes indications of location 1 (Loc 1) and location 2 (Loc 2), expected RSSI from APs 19, identities (IDs) of the APs 19, and locations of those APs. The table 100 is for the structure 20₂ only, although a single table may be used to store information regarding multiple structures 20. The table 100 may be stored in the memory 22 of the MD 12, the memory 42 of one or more of the APs 19, and/or the memory 62 of the server 18.

The locations Loc 1 and Loc 2 as discussed herein are point locations. The locations Loc 1 and/or Loc 2 (and/or any other designated locations), however, may be two-dimensional areas. The discussion herein applies to point locations or area locations. Thus, threshold distances or threshold RSSI values relative to a location as discussed herein may be relative to a point location or to a two-dimensional-area location.

Entries in the table 100 for the identities of the APs 19 are shown as a floor number, followed by an AP number. Thus, “2: AP1” corresponds to the AP 19₁ on the second floor of the structure 20₂. For simplicity of the discussion here, it is assumed that each floor of the structure 20₂ has an identical layout, and an identical positioning of access points. Consequently, “3: AP1” corresponds to an AP 19 located on the third floor of the structure 20₂ at the same location on the third floor as the AP 19₁ on the second floor of the structure 20₂.

Locations are indicated in the table 100 using x-y coordinates, with an origin of the x-y coordinates shown in FIG. 8 as being disposed in the lower left corner of the floor layout. Other origins may be used, such as a floor transition. Coordinates in the table 100 are provided in units of meters. It is assumed that heights (e.g., z dimension values) are known for the respective floors of the structure 20₂. For example, the floors may be separated in height by a common amount such that the z-dimension value is the difference between the present floor and the floor of the AP 19 multiplied by this common amount. Alternatively, the locations of the APs 19 may be given in x, y, and z coordinates in the table 100.

The expected RSSIs shown in the table 100 are examples of values of RSSI expected to be received from the corresponding access points at the indicated locations (here Loc 1 or Loc 2). As shown in the table 100, the expected RSSI at location 2 from AP3, AP6, and AP7 on the third floor of the structure 20₂ (shown in table 100 as “3: AP3,” “3: AP6,” and “3: AP7”) are at or above −70 DBm, and thus higher than the expected RSSIs at location 2 from AP2 and AP8 on the second floor 20_{2,2} (shown in table 100 as “2: AP2” and “2: AP8”).

The expected RSSI values may be pre-determined and stored as part of the table 100, or determined ad hoc by the MD 12 (and thus not provided as part of the table 100). For example, RSSI measurements may be taken at various locations on a floor and those RSSI measurements stored. RSSI values for locations at which measurements were not taken may be determined, e.g., by iteration of locations at which measurements were taken and the RSSI values at those locations. These iterations may be performed in advance of an MD 12 desiring the information, and stored in the table 100. Alternatively, these iterations may be performed, e.g., by the MD 12 or the server 18, ad hoc in response to a request for expected RSSI information for a particular location. Also or alternatively, regions of floors, instead of or in addition to point locations, may be designated and associated with expected RSSI values. For example, a floor may be divided into regions (that may or may not be uniformly shaped, or may be partially uniformly shaped and partially not) and respective expected RSSI values associated with the regions.

Referring also to FIG. 9, a table 102 is alternative example of map information. The table 102 includes lists of IDs of APs 19 for use in MD locating. In this case, which APs 19 to use to determine a location of an MD 12 for each location (point location or region location) has been pre-determined Thus, expected RSSI information may not be provided, e.g., if this will not be needed to determine which APs 19 to use to determine MD location. This information may reduce calculation time and power used by the MD 12 to determine the location of the MD 12 as discussed below. The lists of IDs of APs 19 for use in MD locating may be provided in the separate table 102 and/or may be provided as part of the table 100.

The format of the presentation of the information shown in the table 100 of FIG. 7 or the table 102 of FIG. 9 may take a variety of forms. For example, a table may be provided that lists all the APs and their corresponding locations in a corresponding structure only once, with a list of locations corresponding to each AP 19 provided to indicate at which locations the corresponding AP 19 should be used for determining MD location. Still other configurations of tables of map information may be used. The MDs 12 will be configured to extract the information desired for a desired operation (e.g., by being programmed in accordance with the format of the information, or by being able to determine the format of the information, e.g., using a guide provided with the table, etc.).

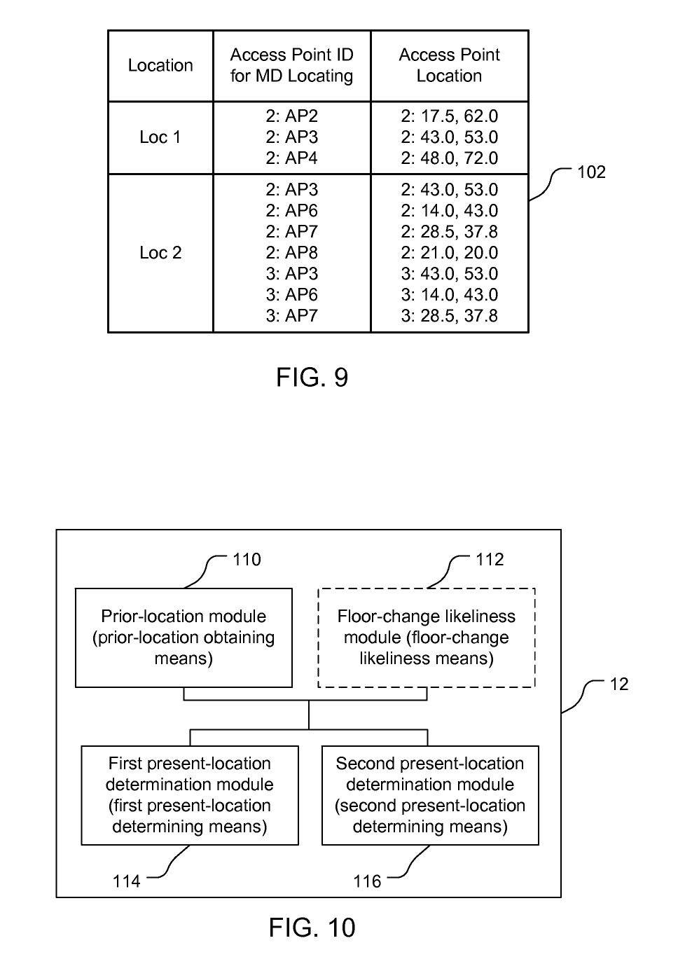

Referring to FIG. 10, with further reference to FIGS. 1 and 3, the mobile device 12 includes a prior-location module (prior-location obtaining means) 110, a floor-change likeliness module (floor-change likeliness means) 112, a first present-location determination module (first present-location determining means) 114, and a second present-location determination module (second present-location determining means) 116 communicatively coupled to each other. The floor-change likeliness module is an optional module and may not be included as part of the MD 12. The modules 110, 112, 114, 116 are functional modules implemented by the processor 21, the software 24, and/or the transceiver 26 as appropriate. Thus, reference to any of the modules 110, 112, 114, 116 performing or being configured to perform a function is shorthand for the processor 21, and/or the transceiver 26, and/or other appropriate hardware (e.g., an ASIC), performing or being configured to perform the function in accordance with the software 24 (and/or firmware, and/or hardware of the processor 21). Similarly, reference to the processor 21 performing a location determining or obtaining function, or a floor-change likeliness function, is equivalent to the modules 110, 114, 116, or the module 112, respectively, performing the function.

The prior-location module 110 is configured to obtain a prior location of the MD 12, e.g., a most-recently determined location of the MD 12. For example, the module 110 may obtain the prior location by accessing the memory 22 and finding a stored indication of that location (although the module 110 could obtain the prior location in another way, e.g., requesting the location from the server 18, calculating the location from stored information, etc.). Preferably, the prior-location module 110 is configured to provide an indication of the structure 20, the floor of the structure 20, and the position on that floor, corresponding to the prior location of the MD 12.

The floor-change likeliness module 112 is configured to determine, and provide an indication of, whether an imminent floor change of the MD 12 is likely. An indication that a floor transition is likely does not necessarily require that an imminent floor transition is more likely than not, i.e., an indication that a floor transition is likely does not necessarily require that there is a greater than 50% chance of a floor transition. For example, the module 112 may provide an indication that an imminent floor change is unlikely or not unlikely. Whether an imminent floor transition is unlikely or not unlikely may be based on one or more of various factors. For example, the module 112 may determine whether an imminent floor transition is unlikely or not unlikely based on one or more of:
1. location relative to a floor transition;
2. time of day;
3. estimated location (position) of the MD 12 relative to a floor transition using prior location, velocity (speed and direction) of the MD 12, and time since determination of the prior location (e.g., to determine whether the estimated location of the MD 12 is at or near a floor transition within a threshold amount of time). Velocity may be determined using two (or more) prior locations of the MD 12 (e.g., the two most recent locations of the MD 12);
4. a pattern of behavior associated with the MD 12 (e.g., time of day and history of changing or not changing floors at that time of day);
5. one or more other factors.

Further, what values of these parameters are indicative of an imminent floor transition of the MD 12 being unlikely or not unlikely may be affected by a definition of imminent (e.g., a threshold amount of time). For example, a larger range of locations around a floor transition may be indicative of an imminent floor transition being not unlikely corresponding to a longer-time definition of imminent than a shorter-time definition of imminent (e.g., an area with a radius of five (5) meters, 25 meters, around a stairwell may be indicative of a not unlikely imminent floor transition if imminent means within five (5) seconds, but an area with only a radius of two (2) meters if imminent means within two (2) seconds).

As an example, here the floor-change likeliness module 112 is configured to determine whether an imminent floor change is unlikely based solely on location of the MD 12 relative to a floor transition. In this case, the floor-change likeliness module 112 may be considered to be a floor-transition proximity module as the MD 12 being proximate to or remote from a floor transition provides the likeliness of an imminent floor change. Examples of floor transitions include stairwells, escalators, and elevators. The module 112 is configured to determine that an imminent floor change is not unlikely if the location of the MD 12, e.g., the prior location provided by the prior-location module 110, is proximate to a floor transition. For example, the module 112 may be configured to determine that an imminent floor change is not unlikely if the location of the MD 12 is within a proximate region near (possibly surrounding) the transition (see region 104 in FIG. 8), etc. The proximate region may be defined by a transition-threshold distance (e.g., a radius), a defined shape (e.g., a rectangle, a polygon, an irregular shape, etc.). That is, the module 112 may be configured to determine that an imminent floor change is unlikely if the location of the MD 12 is remote from any floor transition, i.e., outside all proximate regions of the floor on which the MD is presently located (e.g., as most-recently determined), and that an imminent floor change is not unlikely otherwise. The shape and/or size of the proximate region(s) may depend upon one or more factors such as the type of floor transition, the features (e.g., walls) of the structure around the transition, frequency of use of the transition, RSSI values around the transition, etc. The module 112 is further configured to provide an indication of whether an imminent floor change is unlikely or not unlikely.

The first present-location determination module 114 is configured to determine a present location of the MD 12 when an imminent floor transition of the MD 12 is unlikely. Where likelihood of an imminent floor transition is based only, or at least significantly, on location of the MD 12 relative to a floor transition, the module 114 may be considered to be a remote location determination module as the MD 12 will be remote from a floor transition. Here, remote may not be far in distance, but remote in terms of time to reach the floor transition (e.g., an MD 12 may be close to a floor transition as the crow flies, but remote due to a path that a user of the MD 12 would need to take to reach the floor transition). If the MD 12 includes the floor-change likeliness module 112, then the module 114 may be configured to respond to the floor-change unlikeliness indication from the floor-change likeliness module 112 indicating that an imminent floor change is unlikely by determining a present location of the MD 12.

The module 114 may be configured to determine a present location, or to obtain information for determining the location, of the MD 12 using only APs 19 on the same floor as the prior location of the MD 12 provided by the module 110. The module 114 may determine which APs 19 to use and may do so in one or more of a variety of manners. Alternatively, the module 114 may be provided with a list of the APs 19, e.g., a list provided in the table 102 corresponding to the prior location, to use to obtain information for determining the present location of the MD 12 (i.e., location-determining information) based on the prior location. Alternatively still, the module 114 may use a combination of a list of the APs 19 and a determination (e.g., of strongest RSSIs) regarding the APs 19 to determine which of the APs 19 to use to obtain location-determining information.

As an example of determining which of the APs 19 to use obtain location-determining information, the module 114 may determine the APs 19 that are on the same floor as the prior location provided by the module 110 and that are within a threshold distance of the prior location. Thus, for example, the module 114 may analyze the table 100 to find the locations of the APs 19 on the same floor as the prior location of the MD 12. The module 114 may determine which of these APs 19 are within a threshold distance (e.g., as shown by a circle 120₂ and portions of circles 120₁, 120₃ centered at the MDs 12₁-12₃, respectively, in FIG. 8) of the prior location and use only signals received from these APs 19 to determine the present location of the MD 12. Thus, in the examples shown in FIG. 8, the module 114 in the MD 12₁ (with the prior location corresponding to the location shown for the MD 12₁ in FIG. 8) would use only signals from the APs 19₂, 19₃, 19₄, the module 114 in the MD 12₂ would use only signals from the APs 19₂, 19₃, 19₆, 19₇, 19₈, 19₉, and the module 114 in the MD 12₃ would use only signals from the APs 19₃, 19₅, 19₁₀.

As another example of determining which of the APs 19 to use to obtain location-determining information, the module 114 may determine the APs 19 that have associated actual and/or expected RSSIs above a threshold RSSI value. For example, the module 114 may analyze the table 100 to find a location corresponding to the prior location provided by the module 110, and to identify the APs 19 that are associated with that location, that are located on the same floor as the prior location of the MD 12 provided by the module 110, and that have expected RSSI values at or above a threshold RSSI value, e.g., −70 dBm (with the value depending upon desired performance criteria). The threshold RSSI value may be preset and stored in the memory 22. Alternatively, the module 114 may analyze the table 100 (or another table with AP locations) to determine the locations of the APs 19 that are on the same floor as the prior location provided by the module 110 and from which the MD 12 receives signals. The module 114 may use the APs 19 of these identified APs from which the received signals exceed an RSSI threshold value. Alternatively still, the module 114 may use the APs 19, on the floor of the prior location, whose combination (e.g., average) of expected and actual RSSIs exceed a threshold RSSI value.

The second present-location determination module 116 is configured to determine a present location of the MD 12 when an imminent floor transition of the MD 12 is not unlikely. Where likelihood of an imminent floor transition is based only, or at least significantly, on location of the MD 12 relative to a floor transition, the module 114 may be considered to be a proximate location determination module as the MD 12 will be proximate to a floor transition. If the MD 12 includes the floor-change likeliness module 112, then the module 116 may be configured to respond to the floor-change unlikeliness indication from the floor-change likeliness module 112 indicating that an imminent floor change is not unlikely by determining a present location of the MD 12.

The module 116 may be configured to determine a present location, or to obtain information for determining the location, of the MD 12 using APs 19 on the same floor as the prior location of the MD 12 provided by the module 110, as well as one or more APs 19 on one or more other floors. The module 116 may determine which APs 19 to use and may do so in one or more of a variety of manners. Alternatively, the module 116 may be provided with a list of the APs 19, e.g., a list provided in the table 102 corresponding to the prior location, to use to obtain information for determining the present location of the MD 12 (i.e., location-determining information) based on the prior location. Alternatively still, the module 114 may use a combination of a list of the APs 19 and a determination (e.g., of strongest RSSIs) regarding the APs 19 to determine which of the APs 19 to use to obtain location-determining information.

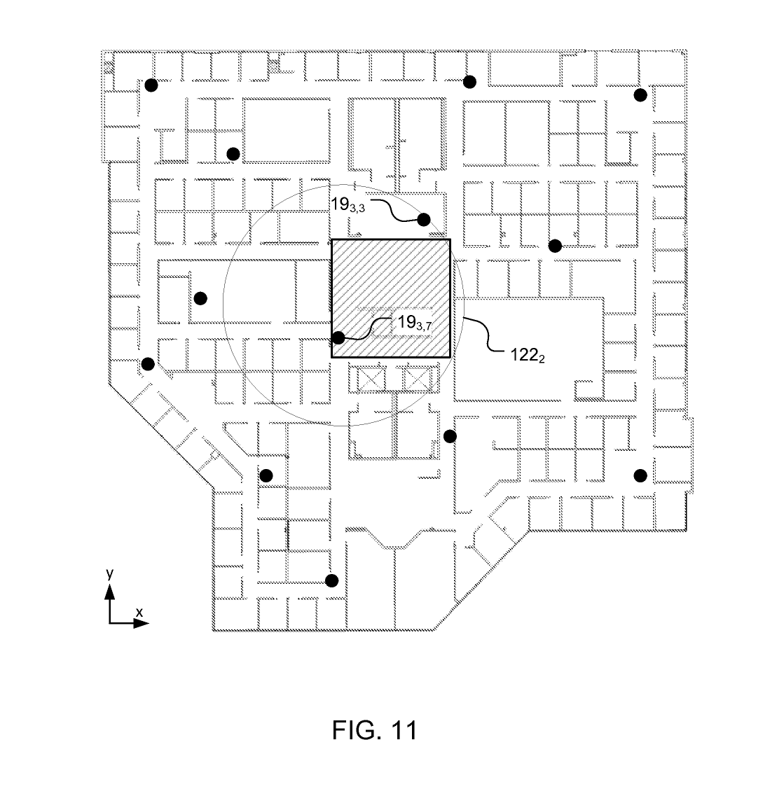

As an example of determining which of the APs 19 to use obtain location-determining information, the module 116 may determine the APs 19 that are within a threshold distance of the prior location. Thus, for example, the module 116 may analyze the table 100 to find the locations of the APs 19 on the same floor as the prior location of the MD 12, and on one or more other floors. Preferably, of the APs 19 on one or more other floors, only APs 19 of the floor(s) adjacent to (i.e., one floor away from) the floor of the prior location are used. The module 116 may determine which of these APs 19 are within a threshold distance of the prior location and use only signals received from these APs 19 to determine the present location of the MD 12. The threshold distance may include vertical distance such that a circle 122₂ on an adjacent floor may be smaller on that floor than the threshold distance (shown by the circle 120₂) on the floor of the prior location. Alternatively, a separate threshold distance for each adjacent floor may be used, and the threshold distances for different adjacent floors may be the same or different. Thus, in the example shown in FIG. 8 and FIG. 11, the module 116 in the MD 12₂ (with the prior location corresponding to the location shown for the MD 12₂ in FIG. 8) would use only signals from the APs 19₂, 19₃, 19₆, 19₇, 19₈, 19₉ on the second floor and the APs 19_{3,3}, 19_{3,6}, 19_{3,7}, on the third floor (and the same APs on the first floor, although not shown), and the module 114 in the MD 12₃ would use only signals from the APs 19₃, 19₅, 19₁₀.

As another example of determining which of the APs 19 to use to obtain location-determining information, the module 116 may determine the APs 19 that have associated actual and/or expected RSSIs above a threshold RSSI value. For example, the module 116 may analyze the table 100 to find a location corresponding to the prior location provided by the module 110, and to identify the APs 19 that are associated with that location, and that have expected RSSI values above a threshold RSSI value. The threshold RSSI value may be preset and stored in the memory 22. Alternatively, the module 116 may analyze the table 100 (or another table with AP locations) to determine the locations of the APs 19 that are on the same floor, or an adjacent floor, as the prior location provided by the module 110 and from which the MD 12 receives signals. The module 116 may use the APs 19 of these identified APs from which the received signals exceed an RSSI threshold value. Alternatively still, the module 116 may use the APs 19, on the floor of the prior location, and adjacent floor(s), whose combination (e.g., average) of expected and actual RSSIs exceed a threshold RSSI value.

Further still, the module 116 may use APs 19 that are within the proximate region 104 of each of the adjacent (or other used) floors. The proximate region 104 may be differently shaped and/or sized for different floors. Alternatively, the module 116 may use APs 19 that are within a communication region near, possibly surrounding, the floor transition on another floor. The communication region is a region where good communication at the floor transition is possible with the APs 19 in that region (e.g., there is a strong signal from each of the APs 19 in the communication region at the floor transition). The communication region may be different from the proximate region for any floor transition on any floor. For example, a transition-threshold distance defining the proximate region may be different than a communication-threshold distance defining the communication region.

The modules 114, 116 may use an estimated present location of the MD 12 instead of the prior location in order to determine which APs 19 to use to determine the actual present location of the MD 12. The estimated present location may be determined and provided by the floor-change likeliness module 112, e.g., by determining a velocity of the MD 12 using two or more prior locations of the MD 12, time differences between those locations, and projecting the velocity using a present time difference relative to the last location determined.

The modules 114, 116 may be configured to implement user-selected criteria for determining position fixes. For example, the user may select to use all available AP signals or a fixed quantity of available AP signals down to a minimum quantity for determining the MD position. Further, the user may select a quantity of probes to use for determining a position fix, from a maximum quantity to a minimum quantity. Each probe is a request to a particular AP and a response from that AP. Thus, the user may select a quantity of probes for a particular AP. Further, the user may select a frequency with which to determine position fixes, such that the frequency is at or below a highest frequency (with a corresponding smallest interval) allowed by the system 10. Position uncertainty decreases with increased number of AP signals used, increased number of probes used, and frequency of fixes at the highest frequency allowed by the system 10. Position uncertainty increases with decreased number of AP signals used, decreased number of probes used, and frequency of fixes at a frequency below the highest frequency allowed by the system 10. For example, position uncertainty may increase if a frequency of fixes is so low (and thus a period between fixes so high) that previously-used data may not be used for a present fix.

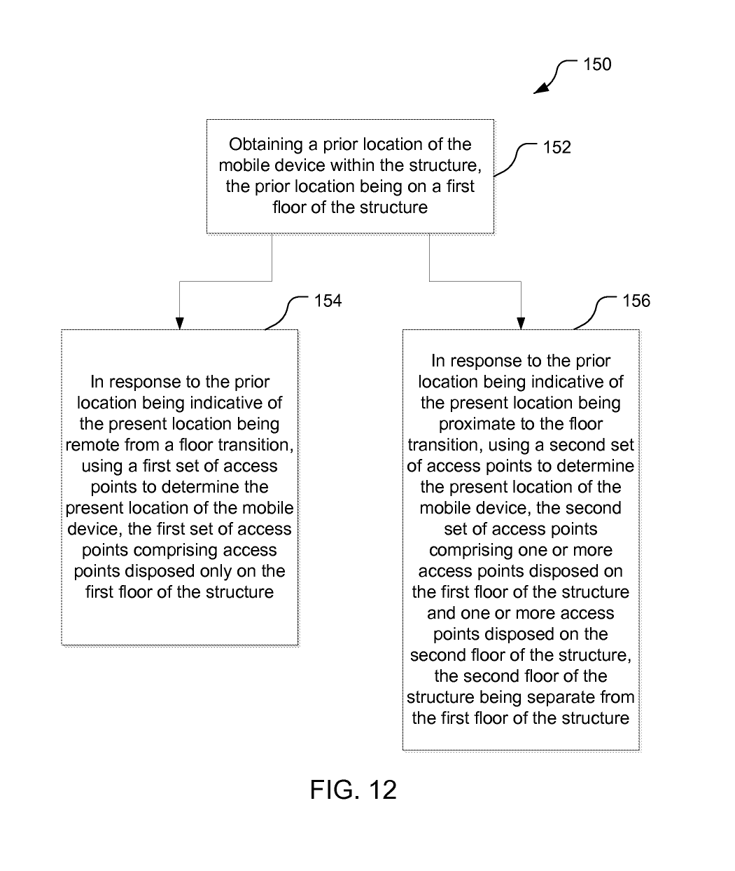

Referring to FIG. 12, with further reference to FIGS. 1-11, a process 150, in the mobile device 12, of determining a location of a mobile device within a structure, includes the stages shown. The process 150 is, however, an example only and not limiting. The process 150 can be altered, e.g., by having stages altered, added, removed, combined, and/or performed concurrently. As shown, stages 154 and 156 are alternative stages, with only one of the stages 154, 156 being performed each time the process 150 is performed by the MD 12.

At stage 152, the process 150 includes obtaining a prior location of the mobile device within the structure, the prior location being on a first floor of the structure. The prior-location module 110 obtains the prior location of the MD 12. For example, the module 110 obtains the prior location by accessing the memory 22 and finding a stored indication of that location (or by another technique of which the module 110 is capable). In this example, the prior-location module 110 provides an indication of the structure 20, the floor of the structure 20, and the position on that floor, corresponding to the prior location of the MD 12.

At stage 154, in response to the prior location being indicative of the present location being remote from a floor transition, the process 150 includes using a first set of access points to determine the present location of the mobile device, the first set of access points comprising access points disposed only on the first floor of the structure. The prior location may be indicative of the present location of the MD 12 being remote from a floor transition if the prior location is beyond a threshold distance of the floor transition, or outside of the proximate region 104 near the floor transition, or if an estimated present location of the MD 12 is beyond the threshold distance or outside the proximate region 104. An indication that the present location of the MD 12 is remote from the floor transition (i.e., imminent floor transition is unlikely) may be provided by the floor-change likeliness module 112.

The first present-location module 114 obtains signals from APs 19 on the floor of the prior location. The module 114 may determine the APs 19 to use, e.g., by using the table 100 to find APs 19 within a threshold distance of the prior location that are on the same floor as the prior location, that have an RSSI within a threshold RSSI and are on the same floor as the prior location, that have an expected RSSI within a threshold RSSI and are on the same floor as the prior location, or by using the table 102 to determine reference APs 19 given the prior location of the MD 12, etc. If a threshold range or threshold RSSI is used, the threshold value may be obtained from the memory 22, from another device (e.g., the server 18), may be obtained ad hoc from a user, etc. The module 114 may use an expected present location of the MD 12, as provided by the floor-change likeliness module 112, instead of the prior location of the MD 12 to determine which APs 19 to use to determine the actual present location of the MD 12.

For example, with the MD 12₁ at Loc 1 on the second floor 20_{2,2} of the structure 20₂ as shown in FIG. 8, and with a threshold distance of 25 meters for APs 19, the MD 12₁ will use APs 19₂, 19₃, 19₄ for determining the present position of the MD 12₁. As an example, if 10 measurement packets are used from each AP 19 to determine a present location of the MD 12₁, then there is a bandwidth reduction of 90 packets (10 packets from each of the nine non-used APs 19) for locating the MD 12₁ at Loc 1.

At stage 156, in response to the prior location being indicative of the present location being proximate to the floor transition, the process 150 includes using a second set of access points to determine the present location of the mobile device, the second set of access points comprising one or more access points disposed on the first floor of the structure and one or more access points disposed on the second floor of the structure, the second floor of the structure being separate from the first floor of the structure. For example, the second floor could be a floor with a higher or lower elevation compared to the first floor of the structure. The prior location may be indicative of the present location of the MD 12 being proximate to a floor transition if the prior location is within a threshold distance of the floor transition, or within the proximate region 104 near the floor transition, or if an estimated present location of the MD 12 is within the threshold distance or inside the proximate region 104. An indication that the present location of the MD 12 is proximate to the floor transition (i.e., imminent floor transition is not unlikely) may be provided by the floor-change likeliness module 112.

The second present-location module 116 obtains signals from APs 19 on the floor of the prior location. The module 116 may determine the APs 19 to use, e.g., by using the table 100 to find APs 19 within a threshold distance of the prior location and are on the same floor as, or the floor(s) adjacent to, the prior location, that have an RSSI that are within a threshold RSSI and are on the same floor as, or the floor(s) adjacent to, the prior location, that have an expected RSSI within a threshold RSSI and are on the same floor as, or the floor(s) adjacent to, the prior location, or by using the table 102 to determine the APs 19 that have been predetermined to use given the prior location of the MD 12, etc. If a threshold range or threshold RSSI is used, the threshold value may be obtained from the memory 22, from another device (e.g., the server 18), may be obtained ad hoc from a user, etc. Further, different threshold values of distance or RSSI, or different proximate region sizes and/or shapes, may be used for different floors. The module 116 may use an expected present location of the MD 12, as provided by the floor-change likeliness module 112, instead of the prior location of the MD 12 to determine which APs 19 to use to determine the actual present location of the MD 12.

For example, with the MD 12₂ at Loc 2 on the second floor 20_{2,2} of the structure 20₂ as shown in FIG. 8, and with a threshold distance of 25 meters for APs 19 on the same floor, and a threshold distance of 18 meters on adjacent floors, the MD 12₂ will use APs 19₂, 19₃, 19₆, 19₇, 19₈, 19₉ on the second floor, and the APs 19_{3,3}, 19_{3,6}, 19_{3,7} (see FIG. 11) on the third floor, for determining the present position of the MD 12₂. As an example, if 10 measurement packets are used from each AP 19 to determine a present location of the MD 12₂, then there is a bandwidth reduction of 60 packets (10 packets from each of the non-used APs 19 on the floor 20_{2,2}) for locating the MD 12₂ at Loc 2, while improving position accuracy, especially if the MD 12₂ transitions floors.

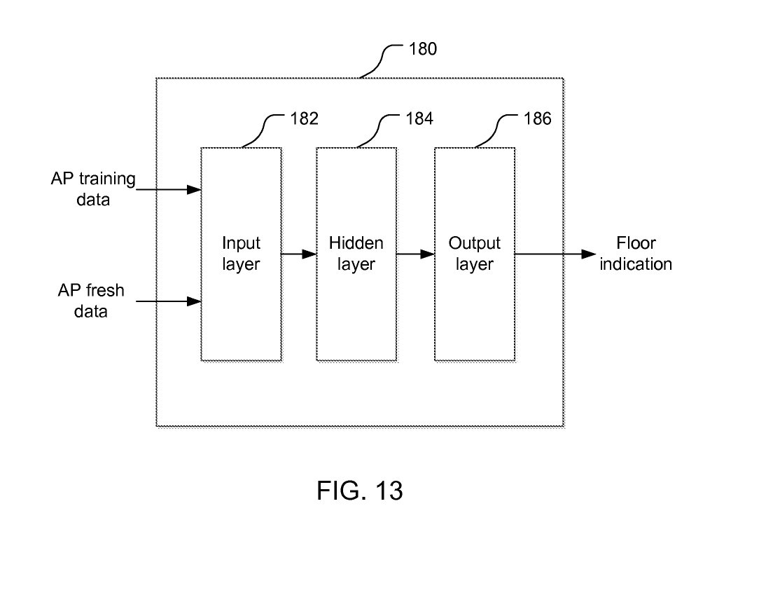

The reference APs 19 used when the MD 12 is proximate to a transition, or imminent floor transition is likely (e.g., based on expected present location) may be provided. For example, the APs 19 used for determining present location or floor transition may be based on proximity to the floor transition and not necessarily RSSI or expected RSSI at the MD 12. For example, referring to FIG. 13, with further reference to FIGS. 1 and 5, a neural network 180 may be used to determine location, at least to the accuracy of on which floor the MD 12 resides. The neural network 180 is preferably disposed in and implemented by the server 18, in particular the processor 60 and the software 64 in the memory 62, although the neural network 180 may be disposed elsewhere, either partially or completely (e.g., in one or more of the APs 19). The neural network 180 includes an input layer 182, a hidden layer 184, and an output layer 186. The input layer 182 is configured to receive data regarding RSSI from APs 19 at various locations. For example, a quantity of the APs 19 may be selected for each floor of each building, such as the nearest five (5) APs 19 to each floor transition on each floor. The RSSI from each of these selected APs 19 at various locations on the respective floors are provided to the input layer 182. The hidden layer 184 stores these data as training data and compares fresh input data (RSSI from the selected APs 19) to the stored training data to make a floor determination for an MD 12, that is, make a determination as to the present floor of the MD 12 based on the fresh data and the training data. The hidden layer 184 provides a result of the determination to the output layer 186, and the output layer 186 provides an indication of the floor of the building 20 corresponding to the present location of the MD 12.

Experimental data for such a neural network has been collected. For collecting the experimental data, five (5) APs 19 were used that were nearest to a floor transition on each of two (2) different floors, resulting in 10 APs total being used. After training data were measured and stored, two (2) different test points were tested on each floor, i.e., RSSI measured and provided to the neural network 180 for a floor determination. The success rates for indicating the correct floor for the four test points were 97.99%, 97.87%, 98.99%, and 99.55% respectively.

Other Considerations

One or more dedicated devices may be provided that measure pressure and send communications indicating the pressures, and information from which the region can be determined, to the server 18 and/or the mobile devices 12.

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

A wireless communication network does not have all communications transmitted wirelessly, but is configured to have at least some communications transmitted wirelessly.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of a computing system.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

1. A method of determining a present location of a mobile device within a structure, the method comprising:
obtaining a prior location of the mobile device within the structure, the prior location being on a first floor of the structure; and
in response to the prior location being indicative of the present location being remote from a floor transition, using a first set of access points to determine the present location of the mobile device, the first set of access points comprising access points disposed only on the first floor of the structure; and
in response to the prior location being indicative of the present location being proximate to the floor transition, using a second set of access points to determine the present location of the mobile device, the second set of access points comprising one or more access points disposed on the first floor of the structure and one or more access points disposed on a second floor of the structure, the second floor of the structure being separate from the first floor of the structure, wherein access point signals from all of the access points in the second set of access points have expected received signal strengths of at least a threshold level proximate to the floor transition on the first floor.

2. The method of claim 1 further comprising determining whether the prior location is indicative of the present location being remote from or proximate to the floor transition by determining whether the prior location is within a transition-threshold distance of the floor transition.

3. (canceled)

4. (canceled)

5. The method of claim 1 wherein the access points in the first set of access points are each separated from the prior location by a respective distance that is equal to or less than a threshold distance when the prior location is indicative of the present location being remote from a floor transition.

6. The method of claim 1 wherein expected received signal strengths, at the prior location, from the access points in the first set of access points are all equal to or greater than a threshold signal strength when the prior location is indicative of the present location being remote from a floor transition.

7. The method of claim 1 further comprising determining whether the prior location is indicative of the present location being remote from or proximate to the floor transition by determining a distance between an estimated position of the mobile device, based on the prior location, relative to the floor transition.

8. The method of claim 1 further comprising determining a likeliness of an imminent floor change.

9. A mobile wireless telecommunications device comprising:
prior-location obtaining means for obtaining a prior location of the mobile wireless telecommunications device, the prior location being on a first floor of the structure;
first present-location determining means for determining, in response to the prior location of the mobile wireless telecommunications device being on the first floor and remote from a floor transition, a present location of the mobile wireless telecommunications device using a first set of access points disposed only on the first floor of the structure; and
second present-location determining means for determining, in response to the prior location of the mobile wireless telecommunications device being proximate to the floor transition, the present location of the mobile wireless telecommunications device using a second set of access points, including at least one access point disposed on the first floor and at least one access point disposed on a second floor of the structure, the second floor of the structure being separate from the first floor of the structure, wherein access point signals from all of the access points in the second set of access points have expected received signal strengths of at least a threshold level proximate to the floor transition on the first floor.

10. The mobile wireless telecommunications device of claim 9 further comprising floor-change likeliness means for providing a likeliness indicator indicating that an imminent floor change of the mobile wireless telecommunications device is either likely or not likely.

11. The mobile wireless telecommunications device of claim 9 wherein the floor-change likeliness means are for determining a proximity of the mobile wireless telecommunications device to a floor-transition.

12. A non-transitory processor-readable storage medium comprising processor-readable instructions to cause a processor to:
obtain a prior location of a mobile device within a structure, the prior location being on a first floor of the structure; and
in response to the prior location being indicative of the present location being remote from a floor transition, use a first set of access points to determine the present location of the mobile device, the first set of access points comprising access points disposed only on the first floor; and
in response to the prior location being indicative of the present location being proximate to the floor transition, determine access points in a second set of access points such that access point signals from all of the access points in the second set of access points have expected received signal strengths of at least a threshold level proximate to the floor transition on the first floor, and use the second set of access points to determine the present location of the mobile device, the second set of access points comprising one or more access points disposed on the first floor of the structure and one or more access points disposed on a second floor of the structure, the second floor of the structure being separate from the first floor of the structure.

13. The non-transitory storage medium of claim 12 further comprising instructions to cause the processor to determine whether the prior location is indicative of the present location being remote from or proximate to the floor transition by determining whether the prior location is within a transition-threshold distance of the floor transition.

14. (canceled)

15. (canceled)

16. The non-transitory storage medium of claim 12 further comprising instructions to cause the processor to determine the access points in the first set of access points such that the access points in the first set of access points are each separated from the prior location by a respective distance that is equal to or less than a threshold distance when the prior location is indicative of the present location being remote from a floor transition.

17. The non-transitory storage medium of claim 12 further comprising instructions to cause the processor to determine the access points in the first set of access points such that expected received signal strengths, at the prior location, from the access points in the first set of access points are all equal to or greater than a threshold signal strength when the prior location is indicative of the present location being remote from a floor transition.

18. The non-transitory storage medium of claim 12 further comprising instructions to cause the processor to determine whether the prior location is indicative of the present location being remote from or proximate to the floor transition by determining a distance between an estimated position of the mobile device, based on the prior location, relative to the floor transition.

19. The non-transitory storage medium of claim 12 further comprising instructions to cause the processor to determine a likeliness of an imminent floor change.
